(19) United States
(12) Patent Application Publication
(10) Pub. No.: US 2008/0090734 A1
(43) Pub. Date: Apr. 17, 2008

(54) DRUG SCREENING AND TARGET IDENTIFICATION USING SPR IMAGING OF TARGET PROTEIN ARRAYS

(75) Inventors: Hao Howard XU, Chino Hills, CA (US); Feimeng Zhou, Temple City, CA (US)

Correspondence Address: MASTERMIND IP LAW PC, 421-A SANTA MARINA COURT, ESCONDIDO, CA, 92029, US

(73) Assignee: The Trustees of California State University, Los Angeles, CA (US)

(21) Appl. No.: 11/871,078

(22) Filed: Oct. 11, 2007

Related U.S. Application Data
(60) Provisional application No. 60/829,021, filed on Oct. 11, 2006.

(51) Int. Cl. C40B 20/08

(52) U.S. Cl. 506/6

(57) ABSTRACT

Drug screening and target identification using surface plasmon resonance imaging (SPRI) of a target protein array is provided. The Target Protein Array/SPRI system is used as parts of a strategy or method for label-free and real-time identification of a target protein or proteins of any inhibitor, agonist or other ligand. Methods that allow for rapidly classifying the mechanism of action of any inhibitor, agonist or other ligand; and for simultaneous identification and purification of an active ingredient of a natural product extract, which acts specifically on a target protein or proteins are provided. Techniques that can be used to prioritize inhibitors, agonists or ligands for lead compound development; to determine the therapeutic index of drug candidates; to assess the range of target proteins of drugs or drug candidates or lead compounds in organisms; and to discover novel target proteins of known drugs or known inhibitors are described.

This application claims priority from U.S. Provisional Application No. 60/829,021, filed on Oct. 11, 2007, incorporated herein by reference.

The inventors acknowledge support from the U.S. National Institutes of Health Research Infrastructure in Minority Institutions (NIH RIMI) grant no. 1P20MD001824 and the U.S. National Institutes of Health Minority Biomedical research Support—Support of Continuous Research Excellence (NIH MBRS-SCORE) grant no. S06GM008101. The U.S. Federal Government has a non-exclusive, non-transferrable, irrevocable, paid-up license to practice this invention on behalf of the United States.

### BACKGROUND

Surface plasmon resonance (SPR) reflectivity measurements are surface-sensitive, spectroscopic methods that can be used to characterize the thickness and/or index of refraction of ultrathin organic and biopolymer films at noble metal (Au, Ag, Cu) surfaces. Surface plasmon resonance spectroscopy has become widely used in the fields of chemistry and biochemistry to characterize biological surfaces and to monitor binding events. The success of these SPR measurements is primarily due to three factors: (i) with SPR spectroscopy the kinetics of biomolecular interactions can be measured in real time, (ii) the adsorption of unlabeled analyte molecules to the surface can be monitored, and (iii) SPR has a high degree of surface sensitivity that allows weakly bound interactions to be monitored in the presence of excess solution species. SPR spectroscopy has been used in life science research, including antibody-antigen interaction (Kyo et al., 2005), nucleic acid hybridization (Song et al., 2002), DNA-regulator protein binding reaction (Perron-Savard et al., 2005) and antimicrobial peptide/membrane interaction (Lequin et al., 2006). Surface plasmon resonance imaging (SPRI) technique has exhibited added capabilities in monitoring biomolecular interactions in a high throughput manner. SPRI has been used to track protein expression (Jung et al. 2004; Ro et al., 2005), read results of immunoassays (Kanda et al., 2004), analyze triple protein interactions (Ro et al., 2005b) and screen for inhibitors of protein-protein interactions (Jung et al., 2005). These methodologies hold increasing promise in speeding up the process of identifying novel hit compounds and/or targets as well as in studying interactions of target-inhibitor pairs.

With the advancement of genomics and functional genomics, availability of novel therapeutic target proteins for developing new medicines is increasing exponentially (Kramer and Cohen, 2004). However, the abundance of drug targets has not yet been translated proportionally into healthy pipelines of drug candidates. There is an obvious need to develop new strategies and technologies to efficiently exploit the newly available therapeutic targets to meet numerous medical needs. For example, in the antibiotics drug discovery arena, currently marked antibiotics target only about 20 of an estimated 200 essential protein targets that exist in most bacterial species (Gil et al., 2004). Although newer bacterial target proteins have been used in high throughput screening (HTS) assays to identify inhibitors (Sun et al., 1996; Baum et al., 2005 & 2006; Wang et al., 2006; Ye et al., 2006, Antane et al., 2006; Yang et al., 2006), the results have yielded few promising lead compounds for further clinical development.

With the increasingly popular high throughput screening (HTS) and exploration of expanded chemical space (in which distance between points approximates compound similarity), it is relatively easy and straightforward to identify antibacterial inhibitors. This involves a straightforward initial screen for the inhibition of bacterial growth by compounds or mixture of compounds (such as natural products). Historically, the discovery of a potent inhibitor was then followed by laborious experimental attempts to identify drug targets and establish mechanisms of action for those discovered antibacterial compounds. When and if the target of the hit compound is identified, antibacterial potency and selectivity can be optimized through the synthesis and testing of structural analogs of the initial hit compound. It is apparent that one of the bottlenecks for antibiotics drug discovery is the difficulty to experimentally link the inhibitor to the cellular target. There is therefore a need for development of fast and comprehensive systems to identify cellular targets of potent antibacterial inhibitors.

### SUMMARY OF THE INVENTION

A massively parallel Target Protein Array is used in conjunction with SPRI for the high throughput identification of: (1) target proteins for existing inhibitors, agonists, antagonists, ligands or modulators discovered separately; and (2) specific ligands (inhibitors, agonists or antagonists) from chemical libraries that interact with various target proteins.

As an example, therapeutic targets for antibiotic drug discovery are emphasized here. The principles can be easily applied to other therapeutic agents in anticancer, cardiovascular and other disease arenas.

It is an aspect of the present invention to use SPR imaging as part of a strategy or method for label-free and real-time identification of a target protein or proteins (among a comprehensive array of target proteins) of any inhibitor (antagonist), agonist or other ligand.

Another aspect of the present invention is to use SPR imaging as part of a strategy or method for label-free and real-time identification of a target family of proteins (among an array of comprehensive target proteins) of any inhibitor (antagonist), agonist or other ligand.

Yet another aspect of the present invention is to use SPR imaging as part of a strategy or method for label-free and real-time identification of a target protein or proteins (among an array of comprehensive target proteins) of an active ingredient(s) (inhibitor, agonist or ligand) of a natural product extract.

The present invention provides a strategy and method for rapidly classifying the mechanism(s) of action of any inhibitor (antagonist), agonist or other ligand.

The present invention also provides a strategy and method for simultaneous identification and purification of an active ingredient(s) (inhibitor, agonist or ligand) of a natural product extract, which acts specifically on a target protein or proteins (among an array of comprehensive target proteins).

In addition, the present invention can be used to prioritize inhibitors, agonists or ligands for lead compound development according to their binding affinity profiles against an array of target proteins or families of target proteins; and to determine the therapeutic index of drug candidates.

Also the present invention can be used to assess the range of target proteins of drugs or drug candidates or lead compounds in organisms; and to discover novel targets proteins of known drugs or known inhibitors.

Furthermore, the present invention provides that Target Protein Array(s)/SPRI system(s) can be used to screen for entities interacting with one or more target proteins from libraries of compounds, ligands or polypeptides.

### BRIEF DESCRIPTION OF THE DRAWINGS

FIG. 1. Hypothetical and simplified SPR Imaging of a Target Protein Array before and after addition of an inhibitor of unknown target protein. Once a comprehensive collection of bacterial target proteins are immobilized onto an appropriate SPR chip, a background SPR image is obtained. After flow-through of an antibacterial inhibitor whose cellular target is unknown, another image is obtained that would identify the target protein to which the inhibitor binds (e.g., the third spotted protein on the first column of proteins on the chip). The spot where specific interaction occurred would have a different thickness or refractive index, which are sensitively detected by SPR imaging.

FIG. 2. Schematic representation of a typical SPRi instrument based on mounting the optical components on two arms situated on a goniometer.

FIG. 3. Schematic representation of a typical SPRi flow cell.

### DETAILED DESCRIPTION

Throughout this specification, the terms “a” and “an” and variations thereof represent the phrase “at least one.” In all cases, the terms “comprising”, “comprises” and any other variations thereof should not be interpreted as being limitative to the elements listed thereafter. Unless otherwise specified in the description, all words used herein carry their common meaning as understood by a person having ordinary skill in the art. In cases where examples are listed, it is to be understood that combinations of any of the alternative examples are also envisioned. The scope of the invention is not to be limited to the particular embodiments disclosed herein, which serve merely as examples representative of the limitations recited in the issued claims resulting from this application, and the equivalents of those limitations.

Polypeptides, proteins and/or potential drug targets (>10 kDa) in general are magnitudes larger in molecular mass than small molecular chemical entities or drug candidates (such as inhibitors, agonists, antagonists or modulators) (at around 500 but generally less than 1500 in molecular weight) that may or may not have been found to possess biological effects on cells or organisms. Detection of binding between polypeptides, proteins, or protein targets attached to solid surface and small molecular chemical entities are difficult due to relative small changes in Response Units (RU) as compared to RU changes typically observed for interactions that occur between molecules with larger mass (such as polypeptide-polypeptide, protein-protein or DNA-DNA interactions). Detection of specific binding between a small molecular chemical entity and its cognate (target) polypeptide or protein among an array of hundreds or thousands of (target or potential target) polypeptides or proteins is even more difficult.

Alternatively, this Target Protein Array/SPR imaging system can be used to directly screen for compounds, ligands or polypeptides with affinity to any of the target proteins from a large collection of chemical, ligand or polypeptide libraries via an integrated autosampler. Once their affinity is demonstrated, the hit compounds, ligands or polypeptide effectors may be further examined for their cellular activities (e.g., antibacterial, antifungal or antitumor activities)

According to the invention, a complete set of genes encoding target proteins for bacteria or other organisms/cell types (such as tumor cells) may be cloned and over-expressed with a variety of translational fusion tags to facilitate purification, analysis, and/or binding to solid surface of SPR chips. These tags may be designed to fuse with either N-terminal, C-terminal, or both ends of the expressed protein. During construction of the Target Protein Array, poly-histidine or poly-cystadine peptides of various lengths separated by zero or a predetermined number of “spacer” amino acids can be designed into the expression vector. Glutathione S transferase (GST) tag sequences with an appropriate number of “spacer” amino acids may be designed into the expression vector into N-terminal, C-terminal, or both ends of the target protein.

A custom Target Protein Array can be constructed, which includes human homologous polypeptides or proteins to the bacterial essential target polypeptides or proteins (whenever they exist and are available) and the array can be used to determine the relative therapeutic index of a drug candidate or drug candidates (i.e., the best antibiotic drug candidate should bind its bacterial target protein with high affinity but bind to human counterpart poorly or not at all).

A custom Target Protein Array can be constructed which includes tumor-specific target proteins as well as normal cell proteins to screen for anticancer agents with potent activity but little or no toxicity (based on binding affinity to tumor-specific target vs. normal cell proteins). For example, the human genome consists of 518 individual protein kinase genes (kinome) (Johnson and Hunter, 2005), many of which are implicated in pathogenesis of cancer diseases. Small molecule inhibitors have been discovered and/or developed into drugs or drug candidates for cancer diseases. An array of protein kinases in conjunction with SPRI may be used to identify additional cellular targets of drugs, drug candidates or lead compounds (spectrum of activity). Alternatively, this kinome Target Protein Array/SPRI system may be used to assess potential toxicity of drugs, drug candidates and lead compounds.

The complete set of over-expressed essential proteins may be isolated and purified using metal chelator affinity chromatography or an equivalent method readily apparent to any person having ordinary skill in the art. These proteins may be arrayed (using a microarrayer) onto corresponding SPR chips in relation to desired fusion tags to be used for binding.

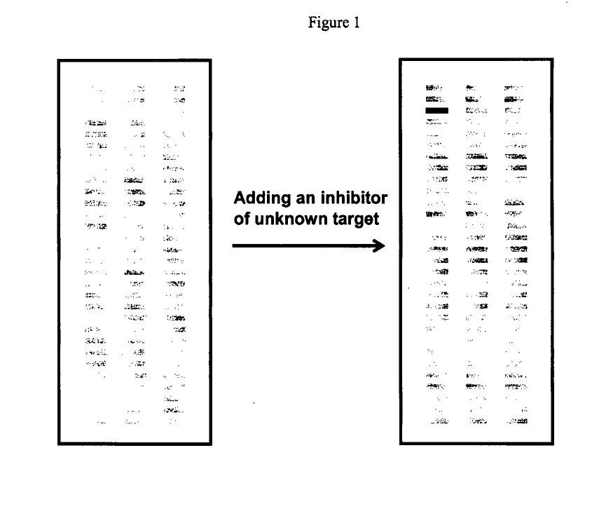

This target protein array may be analyzed using the SPRI technique with several known inhibitors (e.g., triclosan, phosphomycin, indolmycin and mupirocin for bacterial Target Protein Array) as QC (quality control) standards (FIG. 1). A solution of a single inhibitor (or modulator) or a mixture of compounds containing an inhibitory (or effector) ingredient (such as a natural product extract) whose cellular target is unknown flows through the chip surface and SPR images of pre-flow and post-flow are compared and analyzed to identify interactions between the inhibitor (or modulator) and its target protein. Since the exact positions and identities of all target proteins are known, the cellular target of the inhibitor is revealed.

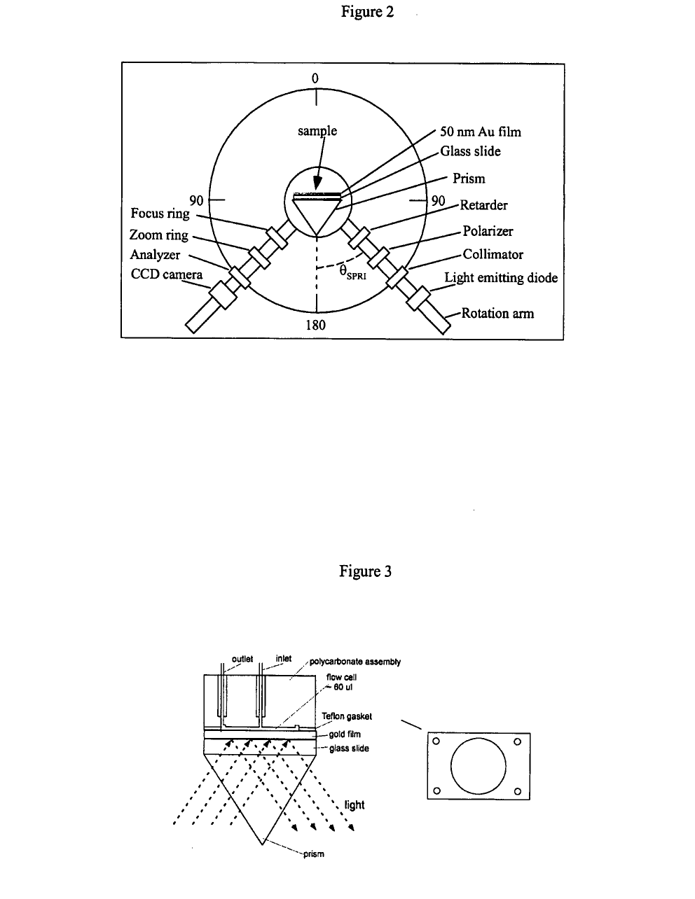

The most popular layout for achieving SPR is the Kretschmann configuration in which light passes through a p-polarizer and then enters a prism with high refractive index (on which a thin layer of metal film is coated) and impinges onto the back of the metal film (on top of the metal film is the sample solution). The reflected light beam is monitored as a reaction occurs at the metal film/solution interface. For SPR imaging (SPRI), the light source is expanded and collimated to have a parallel light beam that irradiates a large area of the metal film through the prism. The reflected light beam is monitored by a CCD camera. A schematic representation of the instrumental set-up is shown in FIG. 2. Other configurations are readily apparent.

Using the methods described herein, a Target Protein Array/SPRI system may be used for various applications. For example, the system may be used to dereplicate a natural product extract which possesses a specific therapeutic activity but without knowledge of the identity of the active ingredient(s) and to eliminate an active natural product extract due to the presence of a known inhibitor. Moreover, a Target Protein Array/SPRI system can be used to screen directly for entities with affinity for one or more of the target proteins within the array from libraries of chemical compounds, ligands or polypeptides for lead discovery. Other applications will be readily apparent to any person having ordinary skill in the art.

Other useful applications of the Target Protein Array/SPRI system include, but are not limited to inclusion of homologous target proteins of a large number of bacterial species (Gram positive or Gram negative; anaerobic or aerobic species) to determine in vitro a spectrum of activities of an antibacterial inhibitor, exploration of cellular metabolic relationships with known metabolites, signal molecules and modulators, and inclusion of multitudes of different therapeutic targets to screen for inhibitors, agonist or modulators. Other applications include probing protein/protein interactions from cell or tissue extracts, inclusion of sequence-distinct therapeutic target proteins of different ethnic groups or individuals to evaluate drug toxicity or effectiveness among individuals of different genetic background (pharmacogenomics) prior to or post market launch of a therapeutic agent, discovery of new mechanisms of action or new indications of known drugs approved for a different indication or even a different disease category (e.g., a known antibiotic might be found to be an excellent anticancer agent), and to identify cellular targets/additional targets of biologics drugs (e.g., monoclonal antibody drugs), to determine the mechanisms of action or mechanisms of toxicity of these agents, or to discover tumor-specific antibodies randomly generated.

### EXAMPLE 1

Phenotypic Profiling of Clinical Isolates of Acinetobacter baumannii

We obtained over thirty clinical isolates of A. baumannii from nosocomial infections in New York City and Los Angeles. All of these isolates are multi-drug resistant (i.e., resistant to at least three antibiotics) as depicted below. Only antibiotics with breakpoints for A. baumannii were used. Antibiotic abbreviations: Amikacin (AMK) Cefepime (FEP) Cefotaxime (CTX) Ceftazidime (CAZ) Ceftriaxone (CRO) Ciprofloxacin (CIP) Doxycycline (DOX) Gatifloxacin (GAT) Gentamicin (GEN) Imipenem (IPM), Levofloxacin (LVX) Meropenem (MEM) Minocycline (MIN) Piperacillin (PIP) Tetracycline (TET) Tobramycin (TOB). Isolates LA 01 to 20 were acquired from Los Angels County while NY-A to NY-H were obtained from New York City. Strains AYE and SDF are known multi-drug resistant strain and susceptible strain, respectively, and were acquired from France. Strains 15869, 17978 and 19606 were obtained from ATCC.

| | AMK | FEP | CTX | CAZ | CRO | CIP | DOX | GAT | GEN | IPM | LVX | MEM | MIN | PIP | TET | TOB |
|---|---|---|---|---|---|---|---|---|---|---|---|---|---|---|---|---|
| LAC 01 | S | R | R | R | R | R | S | R | R | S | I | R | S | R | R | R |
| LAC 02 | I | R | R | R | R | R | S | R | I | I | I | R | S | R | R | R |
| LAC 03 | I | R | R | R | R | R | S | R | R | S | R | I | S | R | R | R |
| LAC 04 | I | I | R | R | R | R | S | S | R | S | S | S | S | R | I | R |
| LAC 05 | R | I | I | I | I | R | S | R | R | S | R | S | S | I | R | R |
| LAC 06 | S | S | R | S | R | R | S | S | R | S | S | S | S | S | R | S |
| LAC 07 | R | R | R | R | R | R | S | R | R | I | R | R | S | R | R | R |
| LAC 08 | I | I | I | I | I | R | S | R | R | S | R | S | S | I | R | R |
| LAC 09 | R | R | R | R | R | R | S | R | R | R | R | R | S | R | R | R |
| LAC 10 | R | R | R | R | R | R | S | R | R | R | R | R | S | R | R | R |
| LAC 11 | S | R | R | R | R | R | R | R | R | S | R | R | R | R | R | S |
| LAC 12 | S | R | R | R | R | R | R | R | R | S | R | S | R | R | R | S |
| LAC 13 | S | R | R | R | R | R | R | R | I | S | R | S | R | R | R | S |
| LAC 14 | S | R | R | R | R | R | R | R | R | S | R | S | R | R | R | S |
| LAC 15 | R | R | R | R | R | R | S | R | I | I | R | R | S | R | R | S |
| LAC 16 | R | R | R | R | R | R | S | R | R | I | R | S | S | R | I | R |
| LAC 17 | I | R | R | R | R | R | S | R | R | I | R | S | S | R | R | R |
| LAC 18 | I | R | R | R | R | R | S | R | R | I | R | S | S | R | R | R |
| LAC 19 | R | R | R | R | R | R | S | I | R | I | I | R | S | R | I | R |
| LAC 20 | I | R | R | R | R | R | S | R | R | I | R | I | S | R | R | R |
| NY A | I | I | R | R | R | R | S | R | R | R | I | R | S | R | I | R |
| NY B | I | R | R | R | R | R | R | R | R | R | R | R | R | R | R | R |
| NY C | R | R | R | R | R | R | S | R | R | R | R | R | S | R | R | R |
| NY D | R | R | R | R | R | R | S | R | R | R | R | R | S | R | R | R |
| NY E | S | R | R | R | I | R | R | R | R | R | R | R | I | R | R | R |
| NY F | R | R | R | R | R | R | S | R | R | R | I | R | S | R | R | R |
| NY G | S | R | R | R | R | R | R | R | S | R | R | R | S | R | R | I |
| NY H | R | R | R | R | R | R | S | R | R | R | I | R | S | R | R | R |
| AYE | R | R | R | R | R | R | S | I | R | R | I | S | S | R | R | R |
| SDF | S | I | S | S | I | S | S | S | S | S | S | S | S | R | I | S |
| 15839 | R | I | R | R | R | R | R | R | R | S | R | S | S | I | R | R |
| 17978 | S | S | S | S | S | S | S | S | S | S | S | S | S | S | S | S |
| 19606 | S | I | I | S | I | S | S | S | R | S | S | S | S | I | I | S |

Antibiotic susceptibility profiles of clinical isolates of A. baumannii and reference strains. R, I, and S denote Resistance, Intermediate and Susceptible, respectively.
Genetic Profiling of Clinical Isolates of A. baumannii

To determine if these clinical isolates of A. baumannii are clonally related and if there is correlation between phenotypic profiles (antibiotic resistance) and genetic profiles, chromosomal DNA restriction digest analysis by pulse field gel electrophoresis was performed. Results indicated that several LA isolates are identical. For example, LAC strains 7, 9 and 10 are identical clonally (see below) and LAC strains 16, 17, 18, 19 and 20 are identical clonally (data not shown).

[image]

Genomic Profiles of clinical isolates LA 1-10 of A. baumannii Genomic DNAs were digested with Apa I restriction enzyme, separated and visualized after pulse field gel electrophoresis.

Ciprofloxacin Resistant Determinants in A. baumannii Isolates

One striking similarity for all clinical isolates (20 from LA, 8 from NY) is that they all uniformly exhibited resistance phenotype to ciprofloxacin, a clinically used fluoroquinolone antibiotic. To determine their ciprofloxacin resistant determinants, DNA sequences of both gyrA and parC genes from these isolates (except one)were PCR amplified and sequenced. Consistent with previous reports, all clinical isolates contain point mutations in the “hot spots” located within quinolone resistant determinant region in gyrA and parC genes, rendering these isolates resistant to ciprofloxacin.

TABLE 1
Mutations in gyrA and parC genes in 20 clinical isolates of A. baumannii from Los Angeles.

| | | gyrA mutations | | | | parC mutations | |
|---|---|---|---|---|---|---|---|
| Group | Isolate # | Gly-81 (GGT) | Ser-83 (TCA) | Ala-84 (GCT) | Glu-87 (GAA) | Ser-80 (TCG) | Glu-84 (GAA) |
| I | 1 | — | — | — | — | — | — |
| II | 1 | — | Leu (TTA) | — | — | — | — |
| III | 8 | — | Leu (TTA) | — | — | Leu (TTG) | — |
| IV | 7 | — | Leu (TTA) | — | — | — | Lys (AAA) |
| V | 3 | — | Leu (TTA) | — | — | Phe (TTT) | — |

### EXAMPLE 2

Detection of Ultra-Trace Amounts of DNA using SPR

Using a flow injection SPR (FI-SPR), we were able to detect oligonucleotide hybridization at femtomolar level. We also demonstrated that the instrument is capable of detecting polynucleotides in real-samples (e.g., cDNAs in Arabidopsis Thaliana leaf extract). Representative time-revolved SPR signal corresponding to the detection of the APx-cs2 cDNA, the SPR signals at chips covered with probes containing single and six base mismatches, and the signal for the hybridization of a reference cDNA (actin cDNA) are respectively shown in curves A-D below. In both experiments, injections of a sample containing 33 pg/mL of total cDNA were performed. Curve C corresponds to the SPR responses of a 35mer probe with 6 bases mismatching to the APx-cs2 gene and curve D is the sensorgram of the actin probe to the same cDNA solution. The inset depicts the sensorgram similar to that of curve A, except that a more diluted cDNA sample (3.3 pg/mL total DNA) was injected. As can be seen, when a six base-pair mismatches was present (curve C), essentially no binding or hybridization occurred (i.e., there was no change in the baseline signal after the injected sample elutes out of the flow cell). When a single base-pair mismatch existed, the SPR signal (curve B) decreased more than 50% in comparison to that for the fully complementary duplex (curve A). These results suggest that the assay is highly specific and even single nucleotide polymorphism can be studied. The results also demonstrate that our instrument is highly sensitive, since the target cDNA in a 3.3 pg/mL total cDNA mixture could even be measured. Such sensitivity is 4-5 orders of magnitude more sensitive than the RT-PCR of the same reaction.

[image]

Sensorgrams showing the detections with a 35mer APx-cs2 probe (curve A) and a 35mer probe with one mismatching base to the APx-cs2 gene (curve B).

### EXAMPLE 3

SPRi Experiments using Oligonucleotide Probes from Four Bacterial Species

We recently applied SPRI to the analysis of DNA/DNA biomolecular interactions in an array format. We have demonstrated that specific binding of oligonucleotide DNA molecules can be measured in an array format in real time (see below). “A” depicts four spots of oligonucleotide probes deposited onto a dextran-modified gold chip, with the two spots on the left corresponding to sequence specific to Escherichia coli DNA and the two spots on the right corresponding to Enterrococcus faecium DNA. When E. faecium specific target DNA was injected, a greater thickness change was observed at the two spots on the right the sensor chip (“B”), suggesting that DNA hybridization had taken place. When E. coli specific target DNA was subsequently injected into the flow cell, the two spots on the left side of the chip become brighter (“C”).

[image]

A SPRi image of a chip fabricated with oligonucleotide probes specific for E. coli (left two spots) and Enterococcus faecium (right two spots); a differential SPRI image collected after E. coli species-specific target DNA was injected in to the flow cell; and (c) a differential SPRI image acquired after E. faecium specific target DNA was injected into a flow cell.

### EXAMPLE 4

Interaction Between Ferulic Acid (FA) and Bovine Serum Albumin (BSA)

By injecting solutions containing different concentrations of FA and recording the resultant sensorgrams, the binding constant between FA and BSA was measured. The fact that protein binding of a small molecule compound such as FA can be measured again indicates that our instrument is highly sensitive. Three different FA concentrations (10, 20, and 50 μM) were injected. A flow rate of 1 mL/h was used.

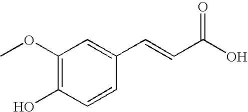

[image]

Representative SPR sensorgrams showing binding of ferulic acid (structure on the left) onto pre-immobilized BSA molecules.

### EXAMPLE 5

Target-Inhibitor Interactions Determined by Surface Plasmon Resonance (SPR)

We have examined specific binding interactions between select target proteins and their specific inhibitors. Our results indicated that SPR can detect specific interactions between protein targets and their specific inhibitors. Representative results of SPR experiments are shown below.

[image]

Specific interaction between TrpS protein (tryptophanyl tRNA synthetase) and its known specific inhibitor indolmycin.

[image]

Dose-dependent specific binding between MurG protein [UDP-N-acetylglucosamine-N-acetylmuramyl-(pentapeptide) pyrophsosphoryl-undecaprenol N-acetylglucosamine transferase] and its known inhibitor ramoplanin as determined by SPR.

1. A method for label-free, real-time, high throughput identification of a target protein comprising use of surface plasmon resonance imaging of a protein array.

2. The method of claim 1, wherein the target protein interacts with a ligand.

3. The method of claim 1, wherein the target protein interacts with a chemical compound.

4. The method of claim 1, wherein the target protein interacts with a polypeptide.

5. The method of claim 2, wherein said ligand is selected from the group consisting of agonist, antagonist and modulator.

6. The method of claim 1, wherein the target protein is a family of proteins.

7. The method of claim 2, further comprising classification of at least one mechanism of action of said ligand.

8. The method of claim 1, further comprising identification and purification of at least one active ingredient ligand of a natural product extract that acts specifically on a target protein.

9. The method of claim 2, further comprising determination of binding affinity profiles for said ligand with said target protein.

10. The method of claim 2, further comprising determination of a therapeutic index of a ligand.
